(19) United States
(12) Patent Application Publication
(10) Pub. No.: US 2023/0273425 A1
(43) Pub. Date: Aug. 31, 2023

(54) LOCATING MATERIAL INTERFACES ON RESONANT MIRROR SYSTEM

(71) Applicant: Microsoft Technology Licensing, LLC, Redmond, WA (US)

(72) Inventors: Xiao Chuan ONG, Bellevue, WA (US); Utku BARAN, Mercer Island, WA (US); Wyatt Owen DAVIS, Bothell, WA (US)

(73) Assignee: Microsoft Technology Licensing, LLC, Redmond, WA (US)

(21) Appl. No.: 17/804,245

(22) Filed: May 26, 2022

Related U.S. Application Data
(60) Provisional application No. 63/268,684, filed on Feb. 28, 2022.

(51) Int. Cl. G02B 26/08; G02B 26/10

(52) U.S. Cl. CPC G02B 26/0858; G02B 26/101

(57) ABSTRACT

Examples are disclosed herein relating to reducing strain in a resonant scanning mirror system. One example provides a thin film piezoelectric-actuated resonant scanning mirror system, comprising a body comprising an anchor portion, a scanning mirror portion, a piezoelectric film support portion, a transmission beam extending from the piezoelectric thin film support portion, and a torsion beam extending between the scanning mirror portion and the transmission beam, and a piezoelectric film formed on the piezoelectric film support portion, the piezoelectric film support portion comprising an area of a surface of the body in which a stress on the piezoelectric film does not exceed a yield stress of the piezoelectric film during oscillation of the scanning mirror portion.

### CROSS REFERENCE TO RELATED APPLICATIONS

This application claims priority to U.S. Provisional Patent Application Serial No. 63/268,684, titled LOCATING MATERIAL INTERFACES ON RESONANT MIRROR SYSTEM, filed Feb. 28, 2022, the entirety of which is hereby incorporated herein by reference for all purposes.

### BACKGROUND

A display device may utilize a resonant scanning mirror system to scan light from a light source to produce a viewable image.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Examples are disclosed that relate to locating material interfaces on a resonant scanning mirror system. One example provides a thin film piezoelectric-actuated resonant scanning mirror system. The resonant scanning mirror system comprises a body comprising an anchor portion, a scanning mirror portion, a piezoelectric film support portion, a transmission beam extending from the piezoelectric thin film support portion, and a torsion beam extending between the scanning mirror portion and the transmission beam. The resonant scanning mirror system further comprises a piezoelectric film formed on the piezoelectric film support portion, the piezoelectric film support portion comprising an area of a surface of the body in which a stress does not exceed a yield stress of the piezoelectric film during oscillation of the scanning mirror portion.

### BRIEF DESCRIPTION OF THE DRAWINGS

FIG. 1 shows a block diagram of an example scanning display system.

FIG. 2 shows a front view of an example resonant scanning mirror system.

FIG. 3 shows a back view of the example resonant scanning mirror system of FIG. 2.

FIG. 4 shows a perspective view of the example resonant scanning mirror system of FIG. 2.

FIG. 5 shows modeled stress data for the example resonant scanning mirror system of FIG. 2.

FIG. 6 illustrates example locations of piezoelectric thin film actuators and strain sensor wiring for the example resonant scanning mirror system of FIG. 2.

FIG. 7 shows modeled surface strain data for a torsion beam and associated transmission beams for the example resonant scanning mirror system of FIG. 2.

FIG. 8 shows a back view of the example resonant scanning mirror system of FIG. 2, and illustrates example adhesive areas.

FIG. 9 shows modeled surface stress data for an anchor portion of the example resonant scanning mirror system of FIG. 2.

FIG. 10 schematically shows a side view of the example resonant scanning mirror system of FIG. 2 attached to a circuit board.

FIG. 11 shows a block diagram of an example computing system.

### DETAILED DESCRIPTION

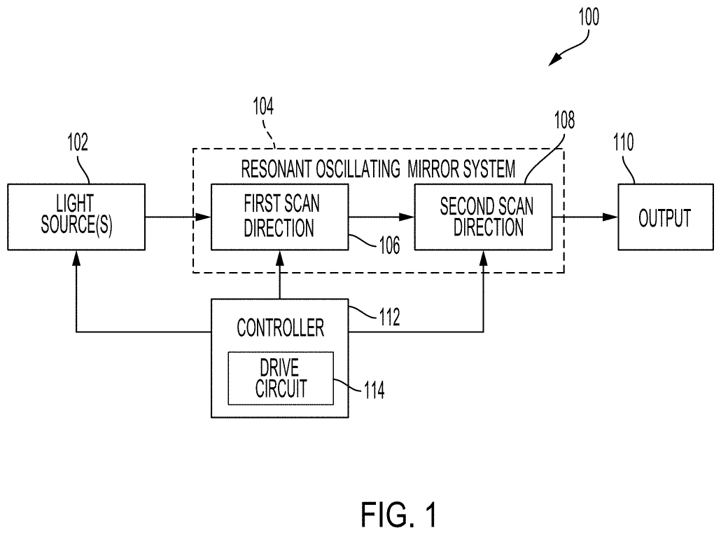

As mentioned above, a display system may utilize a resonant scanning mirror system to scan light from a light source to form an image for display. FIG. 1 shows a block diagram of an example display device 100 comprising one or more light sources 102, (e.g. lasers) that output light to a resonant scanning mirror system 104. The resonant scanning mirror system 104 is configured to scan the light in a first scan direction 106 (e.g. horizontally) at a higher, resonant scanning frequency and in a second scan direction 108 (e.g. vertically) at a lower scanning frequency, such as at a video frame rate. The resonant scanning mirror system 104 may include a single mirror driven in both horizontal and vertical directions, or two mirrors separately driven in horizontal and vertical directions. The resulting image is provided to an output 110 for display. The output 110 may take any suitable form, such as a display surface, projection optics, or waveguide optics, as examples. The display device 100 may be configured as a virtual reality head-mounted display (HMD) device configured to present a fully immersive experience, or as an augmented reality HMD device configured to combine projected virtual imagery with a view of the surrounding real-world environment. In other examples, display device 100 may assume other suitable form, such as that of a head-up display or picoprojector.

The display device 100 further comprises a controller 112 configured to control operation of the light source(s) 102, resonant scanning mirror system 104 and other device components. The controller 112 comprises a drive circuit 114 configured to provide signals to the resonant scanning mirror system 104 to control scanning in each direction.

Designing resonant scanning mirror systems may pose various challenges. For example, a body of a resonant scanning mirror system may be fabricated from a semiconductor wafer (e.g. silicon on insulator wafer). As described in more detail below, the body of the resonant scanning mirror system comprises a mirror connected to transmission beams by flexures. The transmission beams exert torsional forces on the flexures when actuators disposed on the body are energized. Energizing the actuators in a suitable pattern causes resonant oscillation of the mirror, which can be used to scan an image for display.

However, such motion gives rise to stresses within the body of the resonant mirror system. Such stresses may damage other materials that interface the body, and thereby impact reliability. For example, a resonant scanning mirror system may utilize piezoelectric thin films as actuators, metallic thin films as wiring, and/or adhesive films to bond the body to another structure, such as a circuit board. To avoid damaging such structures, a resonant mirror system may be designed to have a more limited range of torsional motion. However, such a mirror system may have a limited scan angle.

Thus, examples are disclosed herein that relate to a resonant scanning mirror system that may address such reliability issues while also providing a high theta-D-product (the product of mechanical scan angle theta and mirror diameter D), for example up to 1.68 mm*22 degrees. Briefly, the disclosed examples comprise a body that includes piezoelectric film support portions each supporting a piezoelectric thin film actuator. The resonant scanning mirror system further comprises a transmission beam extending from each piezoelectric film support portion, and torsion beams each extending between a scanning mirror portion of the body and corresponding pairs of transmission beams. Interfaces between the resonant scanning mirror system body and other materials, such as piezoelectric films, conductors and/or adhesives, are located such that stresses and/or strains in the body do not cause other materials in the interface regions to exceed yield stresses or strains during mirror oscillation. This may help to ensure reliable mirror performance.

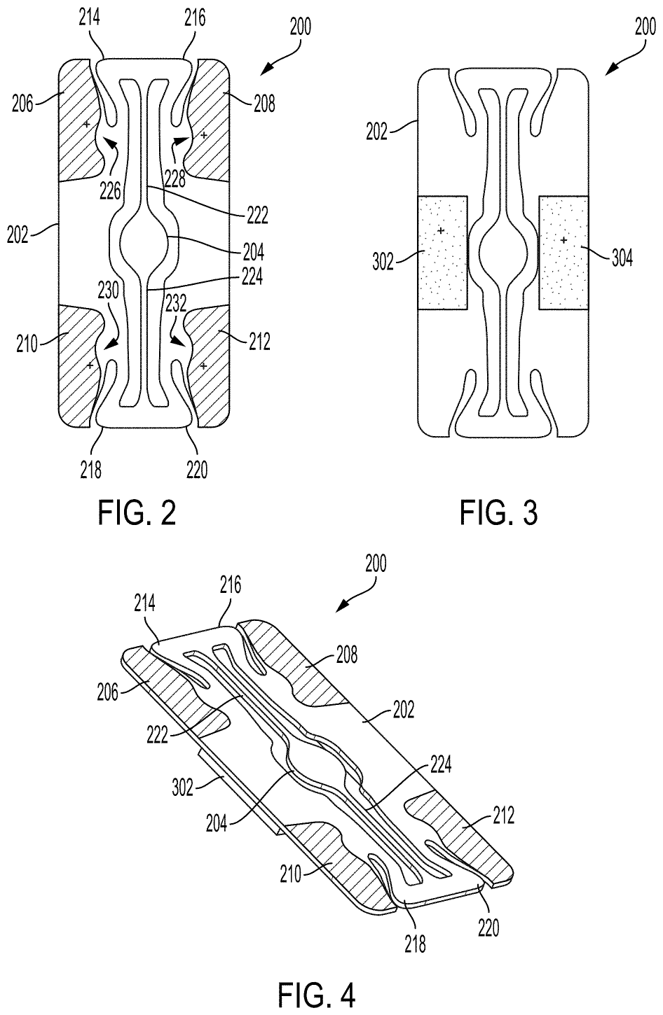

FIGS. 2-4 show an example resonant scanning mirror system 200 configured in such a manner. Resonant scanning mirror system 200 comprises a body 202 comprising a scanning mirror portion 204 and piezoelectric film support portions 206, 208, 210, and 212. Body 202 may be formed from any suitable material. In some examples, body 202 may be formed from a semiconductor wafer, such as a silicon/silicon oxide/silicon multilayer wafer. In such a structure, a silicon layer on which the mirror, piezoelectric thin films, and sensor conductors are formed may be referred to as a device layer. The other silicon layer, separated by the oxide layer from the device layer, may be referred to as a handle layer, and may be removed from most regions other than an anchor region of body 202. In some examples, the device layer may be approximately 200 μm thick, the oxide layer may be approximately 1 μm thick, and the handle layer may be between 300-450 μm. In other examples, a substrate from which body 202 is formed may have any other suitable structure. Body 202 may be formed by removing material from such a wafer by etching. A thickness profile of body 202 may be configured to control dynamic deformation of the resonant scanning mirror during scanning to maintain desired strain characteristics.

Thin films of piezoelectric materials are formed on each of piezoelectric film support portions 206, 208, 210, and 212. The piezoelectric thin films may be formed in any suitable manner, such as by physical vapor deposition (e.g. sputtering), chemical vapor deposition, or by wet chemical techniques (e.g. by application of a sol-gel). The piezoelectric thin films may have any suitable thicknesses. In some examples, the piezoelectric thin films may have a thickness within a range of approximately 1-4 micrometers μm. Electrodes may be formed on each side of each piezoelectric thin film to allow voltages to be applied across the films.

Resonant scanning mirror system 200 includes transmission beams 214, 216, 218, and 220 extending from piezoelectric thin film support portions 206, 208, 210, and 212, respectively. Further, a first torsion beam 222 extends between scanning mirror portion 204 and corresponding transmission beams 214, 216, while a second torsion beam 224 extends between scanning mirror portion 204 and corresponding transmission beams 218, 220. The piezoelectric thin film on each of piezoelectric film support portions 206, 208, 210, and 212 converts electrical energy to mechanical energy. When suitable voltages are applied across each of the piezoelectric thin films, the lattice changes experienced by the piezoelectric film due to the applied electric fields cause body 202 to deform, thereby tilting scanning mirror portion 204. Transmission beams 214, 216 transmit motion from the piezoelectric thin film support portions to torsion beams 222, 224 and scanning mirror portion 204. By modulating the voltages applied to each piezoelectric film support portion 206, 208, 210, 212 in a suitable phase relationship and at a suitable frequency, resonant oscillation of the scanning mirror portion 204 may be achieved.

Deformation of body 202 during oscillation of scanning mirror portion 204 induces stresses in body 202. This can cause stresses in materials that interface body 202. For example, the piezoelectric thin films may experience stress during mirror oscillation due to deformation of piezoelectric film support portions 206, 208, 210, 212. If the stress on a piezoelectric thin film actuator exceeds the yield stress of the piezoelectric thin films, the piezoelectric thin films may be damaged, which may impact operation of resonant scanning mirror system 200.

As such, the shape and area of each piezoelectric film support portion 206, 208, 210, 212 may be configured to avoid regions of body 202 at which stresses on the piezoelectric films would exceed the yield stresses of the piezoelectric thin films during mirror oscillation. In the depicted example, each piezoelectric film support portion 206, 208, 210, 212 comprises a cutout profile, respectively shown at 226, 228, 230, 232, along a side from which a corresponding transmission beam 214, 216, 218, or 220 extends. The term “cutout profile” is used herein to represent a portion of a perimeter that is directed inwardly toward a center of the piezoelectric thin film support portion. Each cutout profile may be shaped based upon modeling of stresses that body 202 experiences during mirror oscillation.

Further, as mentioned above, transmission beams 214, 216, 218, and 220 may be configured to have a stiffness that allows stresses across a relatively larger area of body 202 to remain below yield stresses of the piezoelectric thin films during mirror oscillation compared to other resonant mirror system designs. This may allow for the use of lower drive voltages to operate resonant scanning mirror system 200, and also may increase reliability and lifetime of the piezoelectric film. The yield stresses of the piezoelectric films may vary depending, for example, on the piezoelectric material from which the film is formed and upon film thickness. In some examples, each piezoelectric film support portion is located on an area of body 202 that does not exceed 100 MPa stress during mirror oscillation.

Body 202 is configured to be mounted to an underlying structure, such as a circuit board, via adhesives at anchor portions of body 202. FIGS. 3 and 4 show example anchor portions 302 and 304. Anchor portions 302 and 304 comprise a thicker profile than the rest of body 202. Anchor portions 302, 304 also experience stress due to oscillation of the scanning mirror portion 204. The stresses, over time, may impact the strength of the adhesive. Thus, body 202 may be designed such that stresses on anchor portions 302, 304 do not exceed a yield stress of the adhesive that interfaces anchor portions 302, 304.

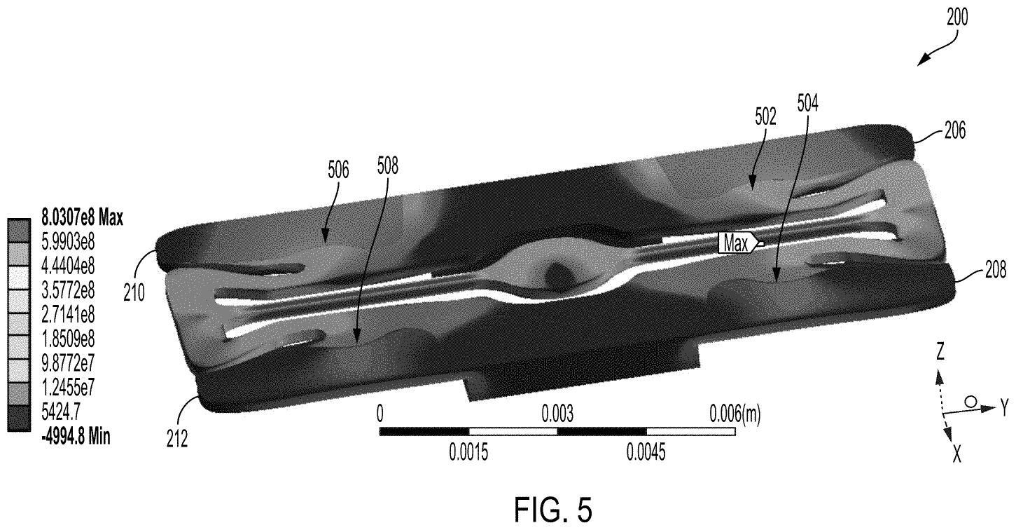

FIG. 5 shows example modeled stress data for resonant scanning mirror system 200. Resonant scanning mirror system 200 is modeled as having a 450 μm thick handle layer and oscillating at a maximum angle of 22 degrees from a plane of body 202 in this example. The label “Max” illustrates a location on body 202 (along a flexure) with maximum stress. A contour between surface areas of relatively higher and lower stress can be seen for each piezoelectric thin film support portion 206, 208, 210, 212, at 502, 504, 506 and 508, respectively. This contour is followed by the cutouts 226, 228, 230, 232 shown in FIG. 2. Thus, the example modeling results of FIG. 5 may be used to design a shape and location of a piezoelectric thin film support portion.

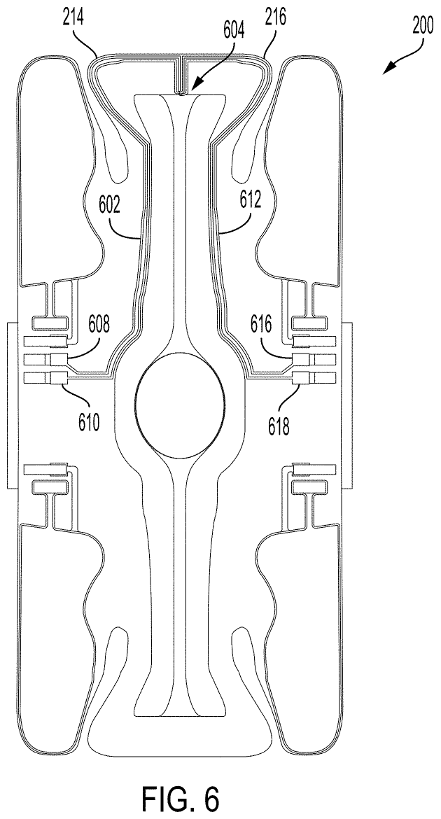

Electrical wiring connecting to sensors (e.g. strain sensors) on a resonant scanning mirror system may be formed as thin conductive films on a surface of body 202. As such, the electrical wiring may be positioned to avoid areas of the surface of body 202 at which a surface strain may exceed a yield strain of the conductive material during oscillation of the mirror. FIG. 6 shows example wiring 602 formed on a surface of resonant scanning mirror system 200. Wiring 602 extends from a strain sensor 604, along transmission beam 214 and to electrical connectors 608 and 610 for interfacing with a printed circuit board. Similarly, second wiring 612 extends from strain sensor 604 along transmission beam 216 to electrical connectors 616 and 618. In this example, strain sensor 604 may comprise a whetstone bridge with four electrical leads. In other examples, any other suitable sensor configuration may be used. In the depicted example, one of electrical connectors 608 and 610 and one of electrical connectors 616 and 618 may receive a sense signal, while the other one of electrical connectors 608 and 610 and the other one of electrical connectors 616 and 618 may receive a bias signal. In some examples, each electrical wiring 602, 612 is located on an area of transmission beam 214 and 216 that does not exceed 0.15% surface strain during mirror oscillation.

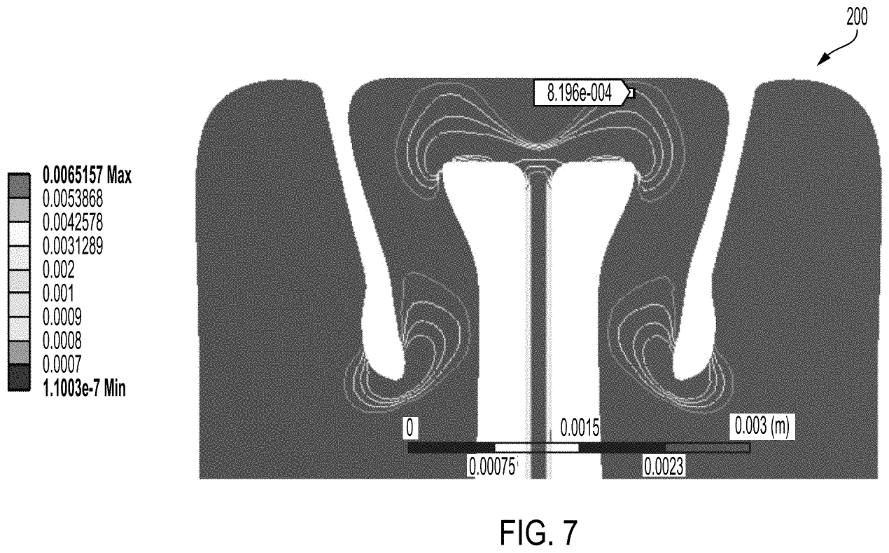

FIG. 7 shows modeled surface strain data for a portion of resonant scanning mirror system 200 along which wiring 602 is located. As can be seen by comparing FIGS. 6 and 7, wiring 602 is routed through areas of lower surface strain, and avoids areas of higher surface strain. Further, strain sensor 604 may also be positioned to avoid areas of higher strain. Avoiding areas of higher strain may help to lower reduce fatigue-related failures of the wiring and the strain sensor due to deformation during mirror oscillation. It will be understood that the wiring locations shown in FIG. 6 are presented for example, and that other suitable wiring routing arrangements may be utilized that avoid regions of unsuitably high surface strain. Further, in other examples, the shapes of the transmission beams, torsion beams, piezoelectric film support portions, scanning mirror portion, and anchor portions may be different than the ones depicted.

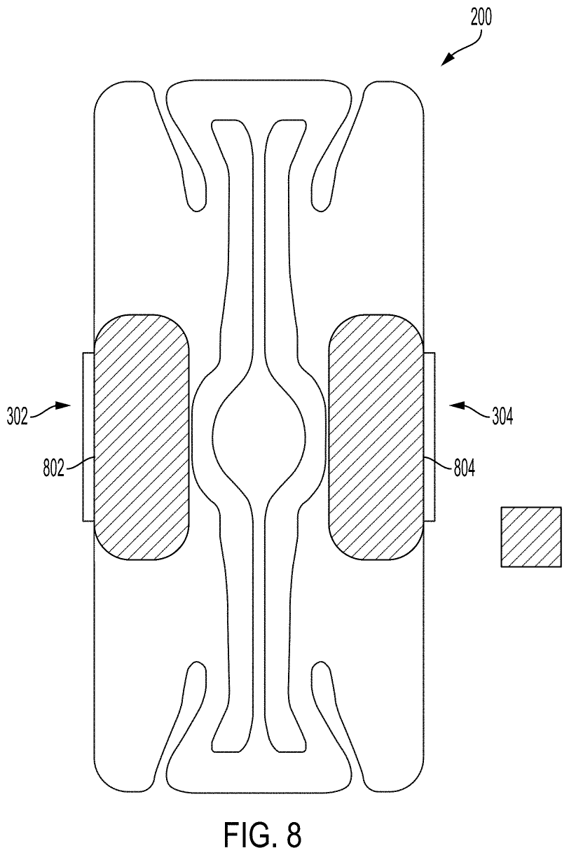

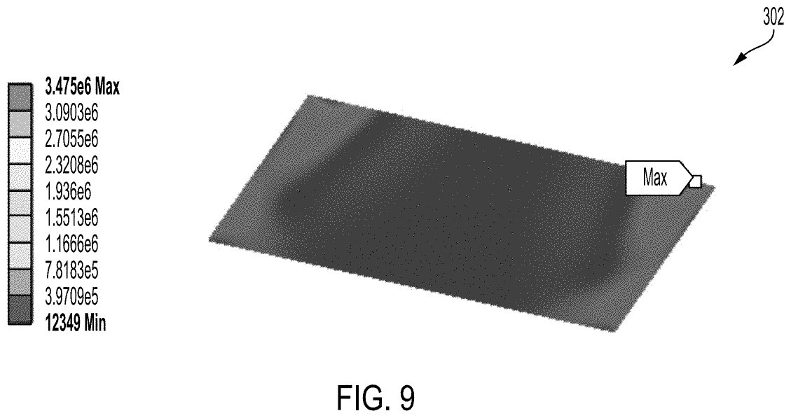

FIG. 8 shows a view of a back of resonant scanning mirror system 200. In this view, anchor portions 302, 304 are shown as having adhesives 802, 804. As mentioned above, anchor portions may be shaped to help reduce stress induced on adhesives 802, 804. For example, adhesives 802, 804 may cover a relatively large adhesive support area to help reduce stress on the adhesive, which may lower drive voltage and improve reliability of adhesive joints. FIG. 9 shows modeled stress data for an adhesive support area of one of the anchor portions 302 of resonant scanning mirror system 200 having a 450 μm handle layer and oscillating at 22 degrees. In the modeled stress data, the adhesive experienced a maximum stress of approximately 3.5 MPa. Such modeling may be used to design an anchor portion such that the adhesive does not experience stress over a yield stress of the adhesive during mirror oscillation.

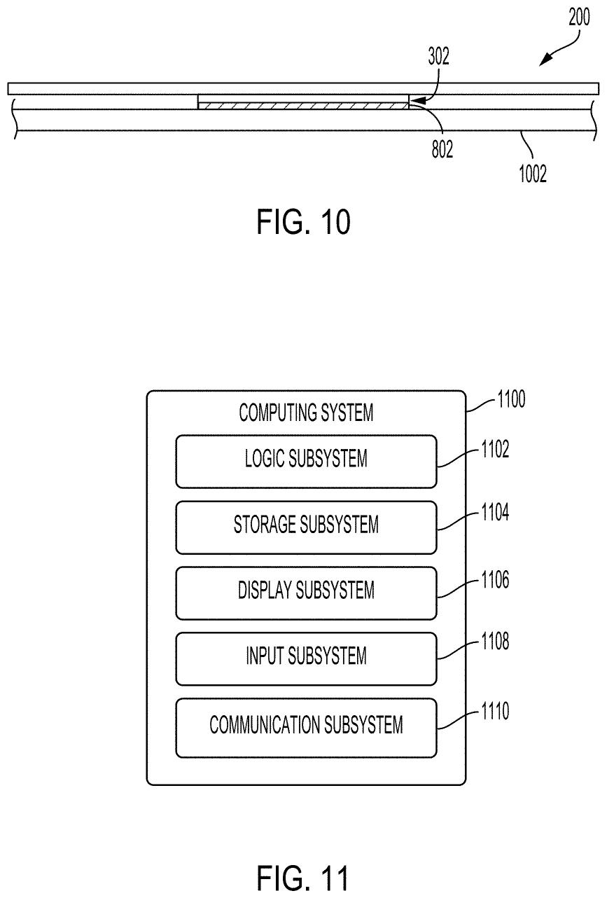

FIG. 10 schematically shows a side view of resonant scanning mirror system 200 mounted to a circuit board 1002 via adhesive 802. As described above, resonant scanning mirror system 200 may be designed such that the stress on adhesive layers that interfaces anchor portions 302, 304 does not exceed a yield stress of the adhesive layers during mirror oscillation.

In some embodiments, the methods and processes described herein may be tied to a computing system of one or more computing devices. In particular, such methods and processes may be implemented as a computer-application program or service, an application-programming interface (API), a library, and/or other computer-program product.

FIG. 11 schematically shows a non-limiting embodiment of a computing system 1100 that can enact one or more of the methods and processes described above. Computing system 1100 is shown in simplified form. Computing system 1100 may take the form of one or more personal computers, server computers, tablet computers, home-entertainment computers, network computing devices, gaming devices, mobile computing devices, mobile communication devices (e.g., smart phone), and/or other computing devices. Computing system 1100 may represent display device 100 or controller 112, as examples.

Computing system 1100 includes a logic subsystem 1102 and a storage subsystem 1104. Computing system 1100 may optionally include a display subsystem 1106, input subsystem 1108, communication subsystem 1110, and/or other components not shown in FIG. 11.

Logic subsystem 1102 includes one or more physical devices configured to execute instructions. For example, logic subsystem 1102 may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

Logic subsystem 1102 may include one or more processors configured to execute software instructions. Additionally or alternatively, logic subsystem 1102 may include one or more hardware or firmware logic machines configured to execute hardware or firmware instructions. Processors of logic subsystem 1102 may be single-core or multi-core, and the instructions executed thereon may be configured for sequential, parallel, and/or distributed processing. Individual components of logic subsystem 1102 optionally may be distributed among two or more separate devices, which may be remotely located and/or configured for coordinated processing. Aspects of logic subsystem 1102 may be virtualized and executed by remotely accessible, networked computing devices configured in a cloud-computing configuration.

Storage subsystem 1104 includes one or more physical devices configured to hold instructions executable by logic subsystem 1102 to implement the methods and processes described herein. When such methods and processes are implemented, the state of storage subsystem 1104 may be transformed—e.g., to hold different data.

Storage subsystem 1104 may include removable and/or built-in devices. Storage subsystem 1104 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage subsystem 1104 may include volatile, nonvolatile, dynamic, static, read/write, read-only, random-access, sequential-access, location-addressable, file-addressable, and/or content-addressable devices.

It will be appreciated that storage subsystem 1104 includes one or more physical devices. However, aspects of the instructions described herein alternatively may be propagated by a communication medium (e.g., an electromagnetic signal, an optical signal, etc.) that is not held by a physical device for a finite duration.

Aspects of logic subsystem 1102 and storage subsystem 1104 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

When included, display subsystem 1106 may be used to present a visual representation of data held by storage subsystem 1104. This visual representation may take the form of a graphical user interface (GUI). As the herein described methods and processes change the data held by the storage machine, and thus transform the state of the storage machine, the state of display subsystem 1106 may likewise be transformed to visually represent changes in the underlying data. Display subsystem 1106 may include one or more display devices utilizing virtually any type of technology. Such display devices may be combined with logic subsystem 1102 and/or storage subsystem 1104 in a shared enclosure, or such display devices may be peripheral display devices.

When included, input subsystem 1108 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 1110 may be configured to communicatively couple computing system 1100 with one or more other computing devices. Communication subsystem 1110 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 1100 to send and/or receive messages to and/or from other devices via a network such as the Internet.

Another example provides a thin film piezoelectric-actuated resonant scanning mirror system, comprising a body comprising an anchor portion, a scanning mirror portion, a piezoelectric film support portion, a transmission beam extending from the piezoelectric film support portion, and a torsion beam extending between the scanning mirror portion and the transmission beam, and a piezoelectric film formed on the piezoelectric film support portion, the piezoelectric film support portion comprising an area of a surface of the body in which a stress on the piezoelectric film does not exceed a yield stress of the piezoelectric film during oscillation of the scanning mirror portion. The resonant scanning mirror system may additionally or alternatively include a strain sensor and wiring extending from the strain sensor along the transmission beam, wherein the wiring is positioned over an area of the transmission beam in which a strain of a surface of the transmission beam does not exceed a yield strain of the wiring during oscillation of the scanning mirror portion. Wherein the transmission beam is a first transmission beam, and wherein the piezoelectric film support portion is a first piezoelectric film support portion, the resonant scanning mirror system may additionally or alternatively include a second transmission beam extending from a second piezoelectric film support portion of the body and connecting to the torsion beam and the first transmission beam. The resonant scanning mirror system may additionally or alternatively include second wiring extending from the strain sensor along the second transmission beam, wherein the second wiring is positioned in an area of the second transmission beam in which a strain of a surface of the second transmission beam does not exceed a yield strain of the second wiring during oscillation of the scanning mirror portion. The wiring and the second wiring may additionally or alternatively be positioned over areas of the first transmission beam and the second transmission beam that do not exceed 0.15% surface strain during oscillation of the scanning mirror portion. The piezoelectric film support portion may additionally or alternatively include a cutout profile along a side from which the transmission beam extends. The piezoelectric film support portion may additionally or alternatively include an area of a surface of the body in which a stress on the piezoelectric film does not exceed 100 MPa.

Another example provides a display device, comprising a resonant scanning mirror system comprising a body comprising an anchor portion, a scanning mirror portion, a piezoelectric film support portion, a transmission beam extending from the piezoelectric film support portion, and a torsion beam extending between the scanning mirror portion and the transmission beam, and a piezoelectric film formed on the piezoelectric film support portion, the piezoelectric film support portion comprising an area of a surface of the body in which a stress on the piezoelectric film does not exceed a yield stress of the piezoelectric film during oscillation of the scanning mirror portion. The anchor portion may additionally or alternatively include a thicker region compared to other portions of the body, and the anchor portion may additionally or alternatively be connected to an underlying structure via an adhesive. A stress on the adhesive at an interface with of the anchor portion may additionally or alternatively be lower than a yield stress of the adhesive. The display device may additionally or alternatively include a strain sensor and wiring extending from the strain sensor along the transmission beam, wherein the wiring is positioned over an area of the transmission beam in which a surface strain does not exceed a yield strain of the wiring during oscillation of the scanning mirror portion. The transmission beam may additionally or alternatively include a first transmission beam, wherein the piezoelectric film support portion comprises a first piezoelectric film support portion, and the display device may additionally or alternatively include a second transmission beam extending from a second piezoelectric film support portion of the body and connecting to the torsion beam and the first transmission beam. The display device may additionally or alternatively include second wiring extending from the strain sensor along the second transmission beam, wherein the second wiring is positioned in an area of the second transmission beam in which a surface strain does not exceed a yield strain of the second wiring during oscillation of the scanning mirror portion. The piezoelectric film support portion may additionally or alternatively include an area of a surface of the body in which a stress on the piezoelectric film does not exceed 100 MPa. The piezoelectric film support portion may additionally or alternatively include a cutout profile along a side from which the transmission beam extends.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A thin film piezoelectric-actuated resonant scanning mirror system, comprising
a body comprising an anchor portion, a scanning mirror portion, a piezoelectric film support portion, a transmission beam extending from the piezoelectric film support portion, and a torsion beam extending between the scanning mirror portion and the transmission beam, and
a piezoelectric film formed on the piezoelectric film support portion, the piezoelectric film support portion comprising an area of a surface of the body in which a stress on the piezoelectric film does not exceed a yield stress of the piezoelectric film during oscillation of the scanning mirror portion.

2. The thin film piezoelectric-actuated resonant scanning mirror system of claim 1, further comprising a strain sensor and wiring extending from the strain sensor along the transmission beam, wherein the wiring is positioned over an area of the transmission beam in which a strain of a surface of the transmission beam does not exceed a yield strain of the wiring during oscillation of the scanning mirror portion.

3. The thin film piezoelectric-actuated resonant scanning mirror system of claim 2, wherein the transmission beam comprises a first transmission beam, wherein the piezoelectric film support portion comprises a first piezoelectric film support portion, and further comprising a second transmission beam extending from a second piezoelectric film support portion of the body and connecting to the torsion beam and the first transmission beam.

4. The thin film piezoelectric-actuated resonant scanning mirror system of claim 3, further comprising second wiring extending from the strain sensor along the second transmission beam, wherein the second wiring is positioned in an area of the second transmission beam in which a strain of a surface of the second transmission beam does not exceed a yield strain of the second wiring during oscillation of the scanning mirror portion.

5. The thin film piezoelectric-actuated resonant scanning mirror system of claim 1, wherein the wiring and the second wiring are positioned over areas of the first transmission beam and the second transmission beam that do not exceed 0.15% surface strain during oscillation of the scanning mirror portion.

6. The thin film piezoelectric-actuated resonant scanning mirror system of claim 1, wherein the piezoelectric film support portion comprises a cutout profile along a side from which the transmission beam extends.

7. The thin film piezoelectric-actuated resonant scanning mirror system of claim 1, wherein the piezoelectric film support portion comprises an area of a surface of the body in which a stress on the piezoelectric film does not exceed 100 MPa.

8. A display device, comprising:
a resonant scanning mirror system comprising:
a body comprising an anchor portion, a scanning mirror portion, a piezoelectric film support portion, a transmission beam extending from the piezoelectric film support portion, and a torsion beam extending between the scanning mirror portion and the transmission beam, and
a piezoelectric film formed on the piezoelectric film support portion, the piezoelectric film support portion comprising an area of a surface of the body in which a stress on the piezoelectric film does not exceed a yield stress of the piezoelectric film during oscillation of the scanning mirror portion.

9. The display device of claim 8, wherein the anchor portion comprises a thicker region compared to other portions of the body, and wherein the anchor portion is connected to an underlying structure via an adhesive.

10. The display device of claim 9, wherein a stress on the adhesive at an interface with of the anchor portion is lower than a yield stress of the adhesive.

11. The display device of claim 8, further comprising a strain sensor and wiring extending from the strain sensor along the transmission beam, wherein the wiring is positioned over an area of the transmission beam in which a surface strain does not exceed a yield strain of the wiring during oscillation of the scanning mirror portion.

12. The display device of claim 11, wherein the transmission beam comprises a first transmission beam, wherein the piezoelectric film support portion comprises a first piezoelectric film support portion, and further comprising a second transmission beam extending from a second piezoelectric film support portion of the body and connecting to the torsion beam and the first transmission beam.

13. The display device of claim 12, further comprising second wiring extending from the strain sensor along the second transmission beam, wherein the second wiring is positioned in an area of the second transmission beam in which a surface strain does not exceed a yield strain of the second wiring during oscillation of the scanning mirror portion.

14. The display device of claim 8, wherein the piezoelectric film support portion comprises an area of a surface of the body in which a stress on the piezoelectric film does not exceed 100 MPa.

15. The display device of claim 8, wherein the piezoelectric film support portion comprises a cutout profile along a side from which the transmission beam extends.

16. A thin film piezoelectric-actuated resonant scanning mirror system, comprising:
a body comprising
a scanning mirror portion,
a torsion beam supporting the scanning mirror portion,
a first anchor portion and a second anchor portion located on opposing sides of the scanning mirror portion,
a first piezoelectric film support portion extending from the first anchor portion and a second piezoelectric film support portion extending from the second anchor portion,
a first transmission beam extending between the first piezoelectric film support portion and the torsion beam, and
a second transmission beam extending between the second piezoelectric film support portion and the torsion beam; and
a strain sensor and wiring extending from the strain sensor along the first transmission beam, the wiring positioned over an area of the first transmission beam in which a surface strain does not exceed a yield strain of the wiring during oscillation of the scanning mirror portion.

17. The thin film piezoelectric-actuated resonant scanning mirror system of claim 16, wherein the wiring is a first wiring, and further comprising second wiring extending from the strain sensor along the second transmission beam, the second wiring positioned over an area of the second transmission beam in which a surface strain does not exceed a yield strain of the second wiring during oscillation of the scanning mirror portion.

18. The thin film piezoelectric-actuated resonant scanning mirror system of claim 16, wherein the strain sensor comprises a whetstone bridge.

19. The thin film piezoelectric-actuated resonant scanning mirror system of claim 16, further comprising
a first piezoelectric film formed on an area of the first piezoelectric film support portion in which a surface strain on the first piezoelectric film support portion does not exceed a yield strain of the first piezoelectric film during oscillation of the scanning mirror portion, and
a second piezoelectric film formed on an area of the second piezoelectric film support portion in which a surface strain on the second piezoelectric film support portion does not exceed a yield strain of the second piezoelectric film during oscillation of the scanning mirror portion.

20. The thin film piezoelectric-actuated resonant scanning mirror system of claim 16, wherein the first piezoelectric film support portion comprises a first cutout profile along a side from which the first transmission beam extends, the first cutout profile being directed inwardly toward a center of the first piezoelectric thin film support portion.
